(19) United States
(12) Patent Application Publication
(10) Pub. No.: US 2008/0166443 A1
(43) Pub. Date: Jul. 10, 2008

(54) Peripheral Die Assembly

(75) Inventors: Kurt A. Busse, Florissant, MO (US); Santiago Solorio, Bridgeton, MO (US); Arthur H. Konwinski, Fort Wayne, IN (US); Eduardo R. Soares Batista, Porto Alegre (BR); Eduardo Carvalho Biehl, Rio Grande do Sul (BR); Andrew K. Wilkinson, Ely (GB)

Correspondence Address: Solae, LLC, 4300 Duncan Avenue, Legal Department E4, St. Louis, MO, 63110, US

(73) Assignee: SOLAE, LLC, St. Louis, MO (US)

(21) Appl. No.: 11/964,538

(22) Filed: Dec. 26, 2007

Related U.S. Application Data
(60) Provisional application No. 60/882,662, filed on Dec. 29, 2006.

(51) Int. Cl. B29C 47/08

(52) U.S. Cl. 425/464

(57) ABSTRACT

A peripheral die assembly for use in an extrusion process is disclosed. The peripheral die assembly includes a cylindrical-shaped hollow die sleeve defining an interior area in communication with a proximal opening and a distal opening as well as a plurality of outlets for permitting egress of extrusion from the peripheral die assembly. A die insert controls the flow of extrusion that enters the die sleeve and is engaged to an end plate through the interior area of the die sleeve. The die insert includes a circular-shaped base with a cone portion that extends outwardly from the proximal opening of the die sleeve and a plurality of raised flow diverters spaced circumferentially along the base. A flow pathway is defined between adjacent flow diverters with one end of the flow pathway in communication with the cone portion and the opposite end in communication with a respective outlet. The configuration of the sleeve die facilitates substantially parallel flow of the extrusion through the peripheral die assembly as the extrusion exits the outlets.

### REFERENCE TO RELATED APPLICATION

This application claims priority from U.S. provisional patent application Ser. No. 60/882,662, filed on Dec. 29, 2006 and is herein incorporated by reference in its entirety.

### FIELD

This document relates to a die assembly, and more particularly to a peripheral die assembly for use in an extrusion process.

### SUMMARY

In one embodiment, a peripheral die assembly may include a die sleeve defining a plurality of outlets. The die sleeve further defines an interior area in communication with the plurality of outlets, and a die insert disposed inside the interior area of the die sleeve. The die insert includes a base with a cone portion extending outwardly from the base, and a plurality of raised flow diverters circumferentially spaced around the circumference of the base with a flow pathway defined between adjacent flow diverters, wherein each flow pathway is in communication with a respective outlet.

In another embodiment, a peripheral die assembly may include a cylindrically-shaped die sleeve defining a plurality of outlets. The die sleeve further defines an interior area in communication with the plurality of outlets. A die insert is disposed inside the interior area of the die sleeve with the die insert including a base with a cone portion extending outwardly from the base. A plurality of raised flow diverters are circumferentially spaced around the base with a flow pathway defined between adjacent flow diverters, wherein the flow pathway is in communication with a respective outlet at one end and the cone portion at the opposite end thereof. An end plate is engaged to the die insert through the die sleeve.

In yet another embodiment, a die insert adapted to engage a die sleeve for use in an extrusion process may include a generally circular-shaped base have a cone portion extending outwardly from the base, and a plurality of raised circumferentially-spaced flow diverters defined around the base. Each of the plurality of flow diverters define a back portion and opposing side portions that meet to form an edge, wherein opposite side portions of adjacent flow diverters collectively define a flow pathway for the flow of extrusion.

In an alternative embodiment, a peripheral die assembly may include a die sleeve having an interior area with open ends. A die insert is operatively engaged to the die sleeve having a front face and a rear face with the front face defining a bottom portion and a plurality of raised, circumferentially-spaced flow diverters in communication with an inner space. A die cone is operatively engaged to the die sleeve and in communication with the plurality of raised, circumferentially-spaced flow diverters for collectively defining a respective flow channel with the flow channel having a tapered configuration along all sides.

Implementation of the above embodiments may include one or more of the following features:

Each of the plurality of flow diverters defining a back portion and opposing tapered side portions that meet at an edge.

The cone portion and the plurality of flow diverters collectively produce a substantially parallel flow by an extrusion flowing through each respective flow pathway.

The flow pathway is tapered along three sides.

The die sleeve defines an inner wall that includes a shoulder adapted to engage the die insert when the die insert is disposed inside the interior area.

The peripheral die assembly further comprises an end plate engaged to the base of the die insert.

The end plate includes a circular-shaped portion and a post extending axially from the end plate.

The die sleeve defines a proximal opening and an opposing distal opening.

The base of the die insert communicates with the distal opening and the cone portion extends outwardly from the proximal opening.

An extrusion flows into the proximal opening of the die sleeve between the cone portion and the inner wall and exits a respective outlet through the flow pathway.

The die sleeve has a generally cylindrical shape with the outlets being equidistantly spaced around the circumference of the die sleeve.

The flow pathway is in communication with a respective outlet at one end and the cone portion at the opposite end thereof.

Each of the raised, circumferentially-spaced flow diverters defines opposing side walls and a face, the face being adapted to engage the die cone when the die cone is engaged to the die insert.

Each of the flow channels is defined by the opposing side walls, the bottom portion and the spherically-shaped die cone.

The die cone and the die insert are collectively disposed within the interior area of the die sleeve.

Each of the flow channels provides for substantially parallel flow by an extrusion.

Additional objectives, advantages and novel features will be set forth in the description which follows or will become apparent to those skilled in the art upon examination of the drawings and detailed description contained herein.

### BRIEF DESCRIPTION OF THE DRAWINGS

FIG. 1 is perspective view of one embodiment of the peripheral die assembly;

FIG. 2 is an exploded view of the peripheral die assembly showing the die insert, die sleeve and die cone;

FIG. 3 is a perspective view of the die insert;

FIG. 4 is a top view of the die insert;

FIG. 4A is a cross-sectional view taken along line 4A-4A of FIG. 4 showing the plurality of flow diverters of the die insert;

FIG. 4B is an enlarged view of FIG. 4A showing a flow pathway defined between each adjacent pair of flow diverters;

FIG. 4C is an enlarged top view of FIG. 4 showing the flow pathway defined between each adjacent pair of flow diverters;

FIG. 5 is a rear view of the die insert;

FIG. 6 is a perspective view of the die insert disposed inside the rear portion of the die sleeve;

FIG. 7 is perspective view of the front portion of the die sleeve engaged to the die cone;

FIG. 8 is a cross sectional view taken along line 8-8 of FIG. 7 showing the front portion of the die sleeve engaged to the die cone;

FIG. 9 is a cross-sectional view taken along line 9-9 of FIG. 1 showing a flow channel defined between the die sleeve, die insert, and die cone arrangement;

FIG. 9A is an enlarged cross-sectional view of FIG. 9 showing the interface between the flow channel and the outlet of the die sleeve;

FIG. 10 is a cross-sectional view of an embodiment of the peripheral die assembly without the die cone;

FIG. 11 is a partial cross-sectional view of the die insert disposed inside the die sleeve showing the configuration of the flow channel;

FIG. 12 is a rear perspective view showing the configuration of the flow channel;

FIG. 13 is a front perspective view showing the configuration of the flow channel;

FIG. 14 is a perspective view of one embodiment of the die insert with scalloped openings; and

FIG. 15 is a perspective view of another embodiment of the die insert with scalloped openings;

FIG. 16 is a perspective view of another embodiment of the peripheral die assembly;

FIG. 17 is an exploded view of the peripheral die assembly shown in FIG. 16;

FIG. 18 is a perspective view of the die insert disposed inside the die sleeve shown in FIG. 16;

FIG. 19 is a top view of the die insert disposed inside the die sleeve shown in FIG. 16;

FIG. 20 is a cross sectional view of the peripheral die assembly taken along line 20-20 of FIG. 19.

FIG. 21 is an enlarged view of the die insert engaged to the die sleeve showing the flow pathways defined between each adjacent pair of flow diverters; and

FIG. 22 is a front perspective view showing the general configuration of the extrusion as it flows through the flow channel defined by the embodiment of the peripheral die assembly shown in FIGS. 16-21.

Corresponding reference characters indicate corresponding elements among the view of the drawings. The headings used in the figures should not be interpreted to limit the scope of the claims.

### DETAILED DESCRIPTION

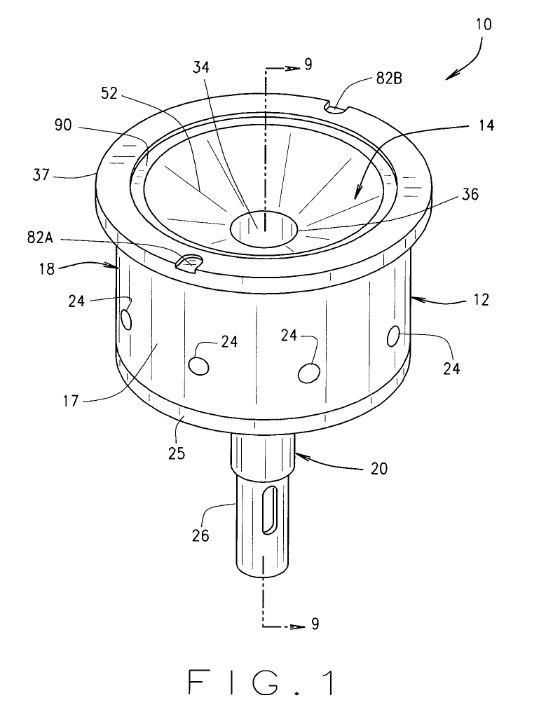

Referring to the drawings, one embodiment of the peripheral die assembly is illustrated and generally indicated as 10 in FIG. 1. The peripheral die assembly 10 may be used in an extrusion process for extruding an extrusion, such as a vegetable protein-water mixture, in a manner that causes substantial parallel alignment of the protein fibers of the extrusion as shall be discussed in greater detail below. In the alternative, the extrusion may be made from a meat and/or vegetable protein-water mixture.

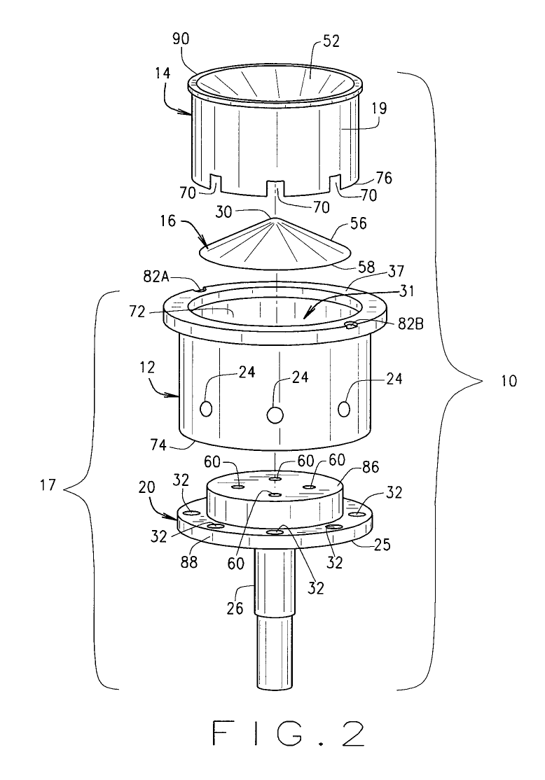

As shown in FIGS. 1 and 2, the peripheral die assembly 10 may include a die sleeve 12 having a cylindrical-shaped two-part sleeve die body 17. The sleeve die body 17 may include a rear portion 18 coupled to an end plate 20 that collectively define an internal area 31 in communication with opposing openings 72, 74. The die sleeve 12 may be adapted to receive a die insert 14 and a die cone 16 for providing the necessary structural elements to facilitate substantially parallel flow of the extrusion through the peripheral die assembly 10 during the extrusion process.

In one embodiment, the end plate 20 of the die sleeve 12 may be secured to a die cone 16 adapted to interface with the die insert 14 when the end plate 20 is secured to the rear portion 18 of the die sleeve 12 during assembly of the peripheral die assembly 10. As further shown, the rear portion 18 of die sleeve 12 defines a plurality of circular-shaped outlets 24 along the sleeve body 17 which are adapted to provide a conduit for the egress of extrusion from the peripheral die assembly 10 during the extrusion process. In the alternative, the plurality of outlets 24 may have different configurations, such as square, rectangular, scalloped or irregular. As further shown, the rear portion 18 of the die sleeve 12 may include a circular flange 37 that surrounds opening 72 and defines a pair of opposing slots 82A and 82B that are used to properly align the die sleeve 12 when engaging the die sleeve 12 to the extruding apparatus (not shown).

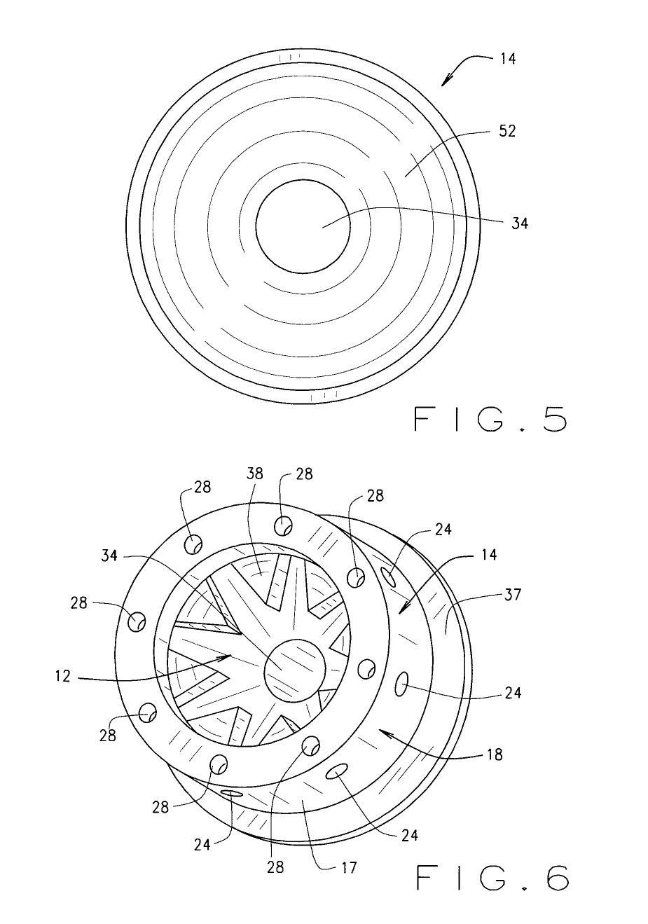

Referring to FIGS. 3-5, one embodiment of the die insert 14 may include a cylindrical-shaped die insert body 19 having a front face 27 in communication with an opposing rear face 29 through a throat 34 defined between the rear and front faces 27, 29. The front face 27 of the die insert 14 may define a slanted bottom portion 64 in communication with a plurality of raised flow diverters 38 that are spaced circumferentially around the front face 27 of the die insert body 19 and which surrounds an inner space 44 that communicates with throat 34. In one embodiment, the flow diverters 38 may have a pie-shaped configuration, although other embodiments may have other configurations adapted to divert and funnel the flow of the extrusion through the outlets 24 of the peripheral die assembly 10. In addition, the front face 27 of the die insert 14 defines a plurality of openings 70 adapted to communicate with a respective outlet 24 with the openings 70 being circumferentially spaced around the peripheral edge of the die insert 14.

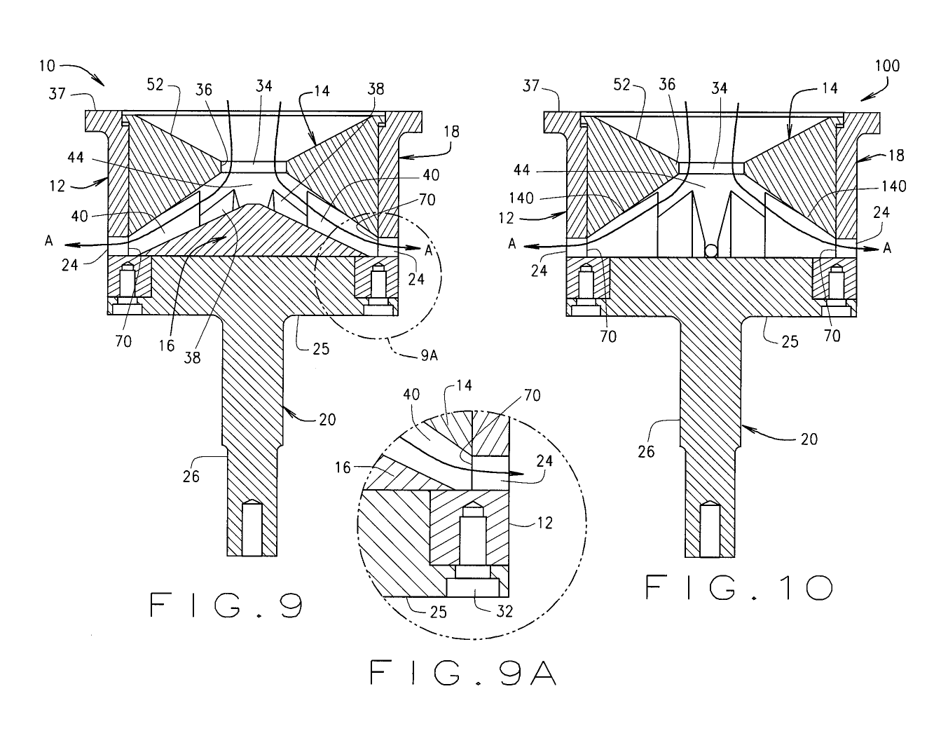

Referring to FIGS. 1 and 2, the throat 34 defined between the rear and front faces 27, 29 of the die insert 14 communicates with an opening 36 (FIG. 9) which is in communication with a well 52 defined along the rear face 29 of die insert body 19. In one embodiment, the well 52 has a generally bowl-shaped configuration surrounded by a flange 90. The well 52 may be adapted to permit the extrusion to enter the throat 34 and flow into the inner space 44 (FIG. 3) through opening 36 having substantially parallel flow as the extrusion enters the die insert 14 from an extrusion apparatus (not shown). In other embodiments, the well 52 may be sized and shaped to different configurations suitable for permitting substantially parallel flow of the extrusion through the throat 34 as the extrusion enters the front face 29 of the die insert 14.

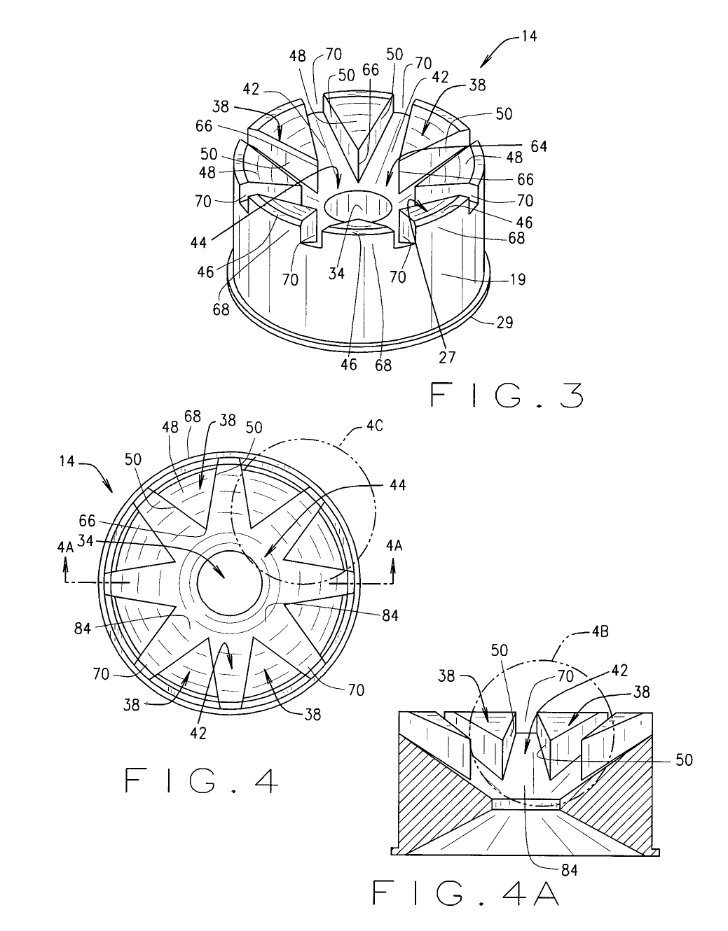

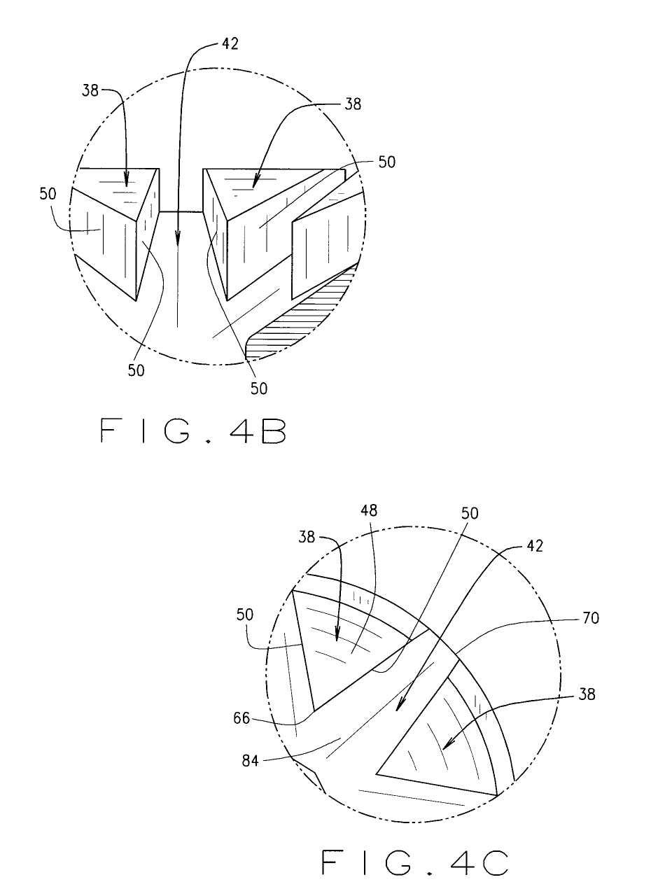

As shown specifically in FIGS. 3, 4 and 4A, each flow diverter 38 has a raised configuration defining a curved back portion 68 having a beveled peripheral edge 46 in communication with opposing side walls 50 that meet at an apex 66. In addition, each flow diverter 38 defines a pie-shaped surface 48 adapted to interface with die cone 16. As further shown, the opposing side walls 50 of adjacent flow diverters 38 and the bottom portion 64 of the die insert 14 collectively define a tapered flow pathway 42 that forms a portion of a flow channel 40 when the peripheral die assembly 10 is fully assembled. The flow pathway 42 may be in communication with an entrance 84 at one end and a respective outlet 24 at a terminal end of the flow pathway 42.

As further shown, each flow pathway 42 has a three-sided tapered configuration collectively defined between the opposing side walls 50 of adjacent flow diverters 38 and the slanted configuration of bottom portion 64 of the die insert 14. In one embodiment, this three-sided tapered configuration gradually tapers inwardly on all three sides of the flow pathway 42 from the entrance 84 to the outlet 24.

In an embodiment, the front face 27 of the die insert 14 may include eight flow diverters 38 that define a respective flow pathway 42 between adjacent flow diverters 38 for a total of eight flow pathways 42. However, other embodiments may define at least two or more flow diverters 38 circumferentially spaced around the peripheral edge of the 76 of the die insert 14 in order to provide at least two or more flow pathways 42 along the front face 27 of the die insert 14.

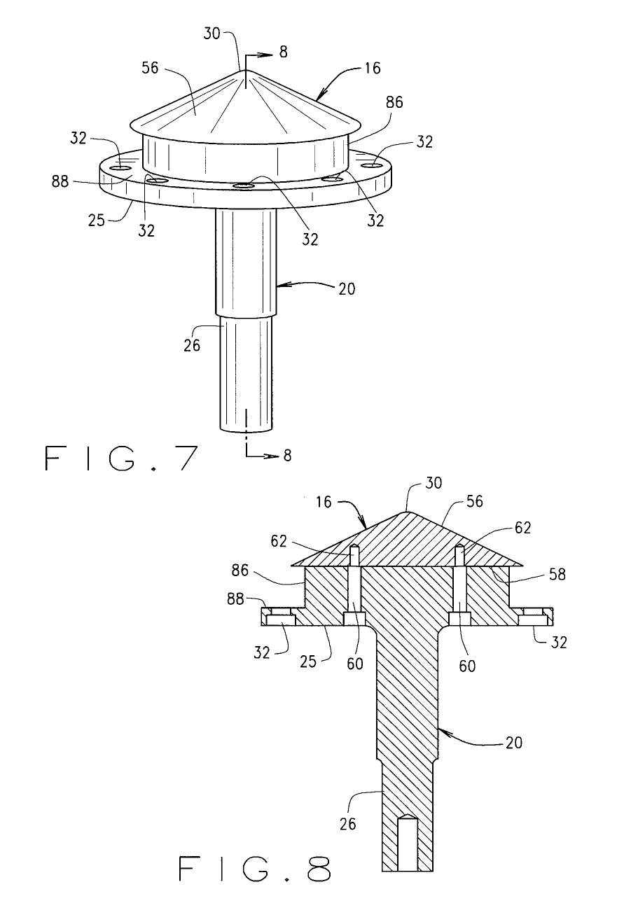

As shown in FIGS. 7 and 8, the end plate 20 of the die sleeve 12 may include a post 26 secured to the die cone 16 through a circular-shaped plate 25. The die cone 16 may define a conical side 56 and an opposite flat side 58. In an embodiment, the conical side 56 of the die cone 16 may have a conical-shaped configuration having an apex 30; however, the die cone 16 may have other suitable shapes, such as generally spherical or rounded configurations. In one embodiment, the flat side 58 of the die cone 16 may be secured to the end plate 20 of the die sleeve 12 when assembling the peripheral die assembly 10.

Referring to FIGS. 2 and 8, the flat side 58 of the die cone 16 may be secured to the end plate 20 of die sleeve 12 that includes a circular-shaped plate 25 and post 26. The circular-shaped plate 25 has a base plate 86 that defines a plurality of channels 60 that correspond to a plurality of respective recesses 62 defined along the opposite flat side 58 of the die cone 16. In particular, the channels 60 and recesses 62 are adapted to receive corresponding bolts or the like (not shown) that secure the circular-shaped plate 25 to the die cone 16. In addition, the circular-shaped plate 25 defines a plate flange 88 that surrounds the plate base 86. In another embodiment, the post 26 may be a separate structural element adapted to be secured to the plate 25 using a thread and bolt arrangement.

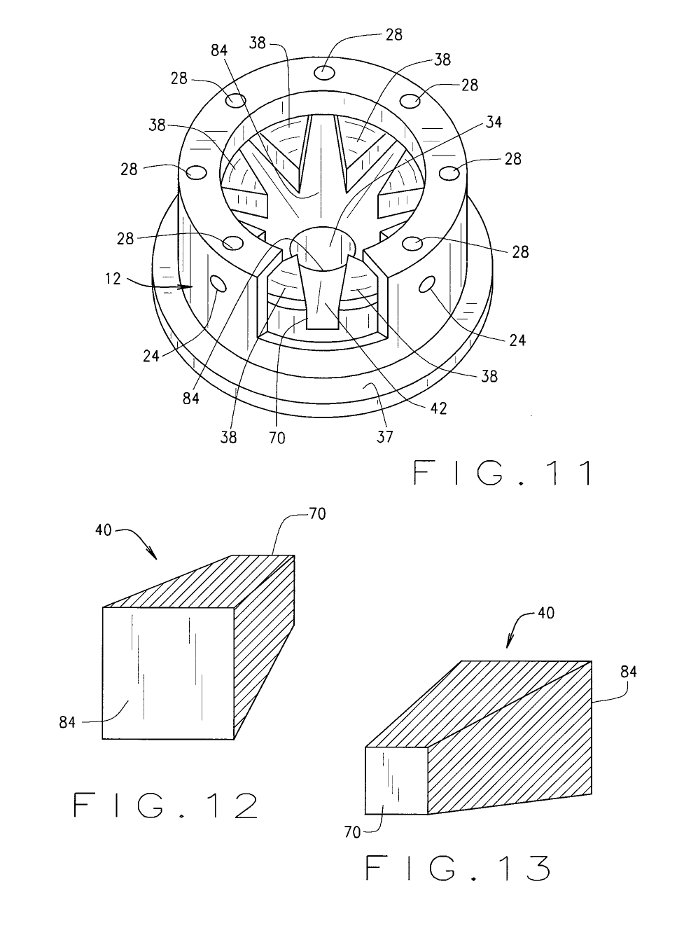

Referring to FIGS. 6, 7, 8 and 11, the rear portion 18 of die sleeve 12 defines a plurality of circumferentially-spaced holes 28, while the plate flange 88 of die sleeve 12 defines a corresponding plurality of circumferentially-spaced channels 32 with a hole 28 adapted to be aligned with a respective channel 32. A corresponding number of bolts or the like (not shown) may be adapted for insertion through a respective aligned hole 28 and channel 32 in order to secure the rear portion 18 to the end plate 20 of the die sleeve 12 during assembly of the peripheral die assembly 10.

Referring to FIG. 9, when the peripheral die assembly 10 is fully assembled the die insert 14 is disposed within the rear portion 18 of the die sleeve 12 which is secured to the end plate 20 of the die sleeve 12 such that the conical side 56 of the die cone 16 is oriented toward the area 31 and encased between the rear and front portions 18 and 20. In this orientation, the conical side 56 is operatively associated with the front face 27 of the die insert 14. As such, the opposing side walls 50 of each adjacent flow diverter 38, the bottom portion 64 of the die insert 14, and the conical side 56 of the die cone 16 collectively define a respective flow channel 40 in communication with a respective outlet 24. The flow channel 40 defined between the die sleeve 12, die insert 14 and die cone 16 as described above may be tapered on all four sides of the flow channel 40. Accordingly, the flow channel 40 gradually tapers inwardly on all four sides from the entrance 84 to the outlet 24 of each flow channel 40.

Referring to FIG. 9A, an enlarged view illustrating the flow pathway A through flow channel 40 is shown. Specifically, flow channel 40 communicates with the outlet 24 through opening 70 defined by the die insert 14. In one embodiment, the transition from the opening 70 to the outlet 24 is seamless such that the meat and/or vegetable protein-water mixture that is extruded from the peripheral die assembly 10 has fibers that are substantially aligned.

During the extrusion process, the peripheral die assembly 10 may be operatively engaged with an extruding apparatus (not shown) that produces an extrusion that contacts the well 52 defined by the rear face 29 of the die insert 14 and flows into the throat 34 and enters the inner space opening 36 as indicated by flow path A. The extrusion may enter the inner space 44 defined by the die insert 14 and enter the entrance 84 of each tapered flow channel 42. As noted above, the extrusion then flows through each flow channel 42 and exits from a respective outlet 24 in a manner that causes the substantial alignment of the vegetable protein fibers in the extrusion produced by the peripheral die assembly 10.

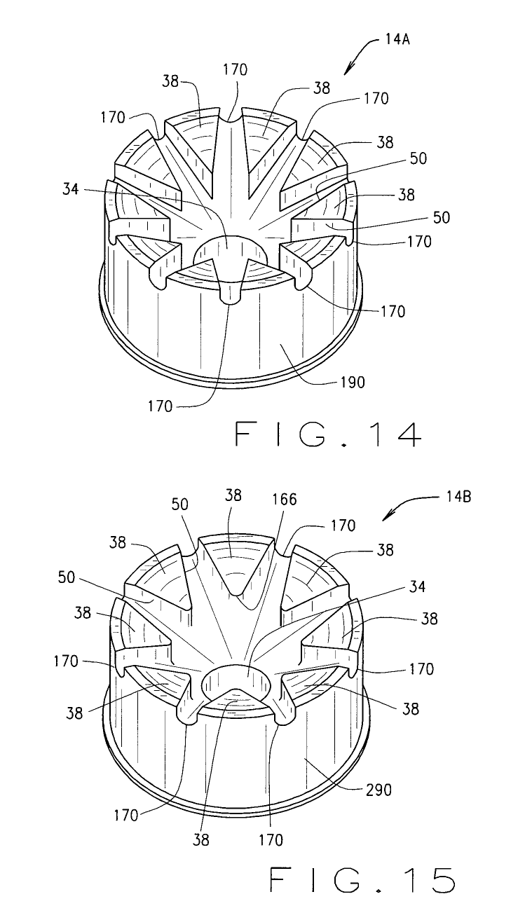

Referring to FIGS. 12 and 13, the shape and size of the flow channel 40 is illustrated that shows the four way tapered configuration of each flow channel 40. As shown, the flow channel 40 gradually tapers along all four sides from the entrance 84 to the opening 70 of the flow channel 40 in a manner that promotes substantially parallel flow of the extrusion. In addition, the entrance 84 may have a greater cross-sectional area than the outlet 70 in order to promote the gradual tapering of the flow channel 40 described above.

In an alternative embodiment shown in FIG. 10, the peripheral die assembly 100 may include a die sleeve 12 operatively engaged to a die insert 14 that are similar in construction and assembly as found in the embodiment of the peripheral die assembly 10. However, the peripheral die assembly 100 of this embodiment lacks the die cone 16 such that a larger tapered flow channel 140 is defined between the die sleeve 12 and die insert 14.

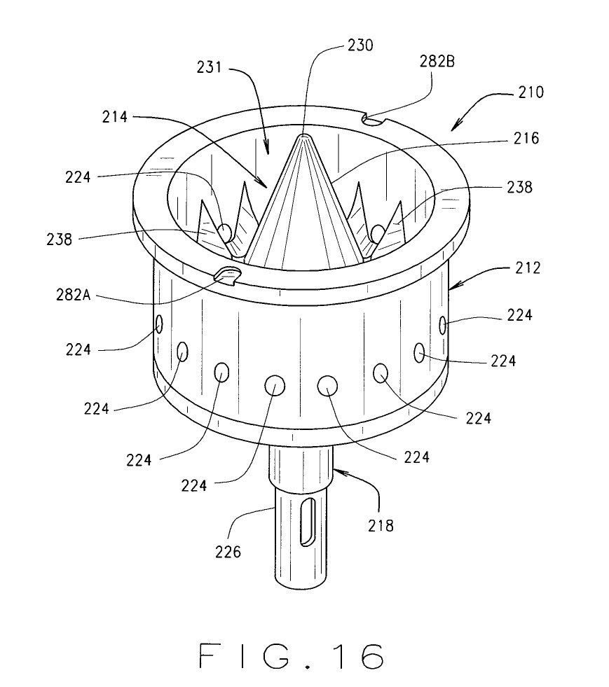

In one embodiment shown in FIG. 14, a die insert designated 14A, may define a body 190 having a plurality of flow diverters 38 that are circumferentially spaced around the die insert 14A. The opposing walls 50 of each adjacent flow diverter 38 collectively define a gradually tapered flow pathway in communication with a scalloped opening 170 defined at each end of the flow pathway. In addition, the die insert 14A may define ten flow diverters 38. In another embodiment shown in FIG. 15, a die insert designated 14B, may define a body 290 having eight flow diverters 38 that are also circumferentially spaced around the die insert 14B. Further, each flow diverter 38 has a rounded apex 166, rather than a pointed apex 66 defined by the other embodiments of the die insert.

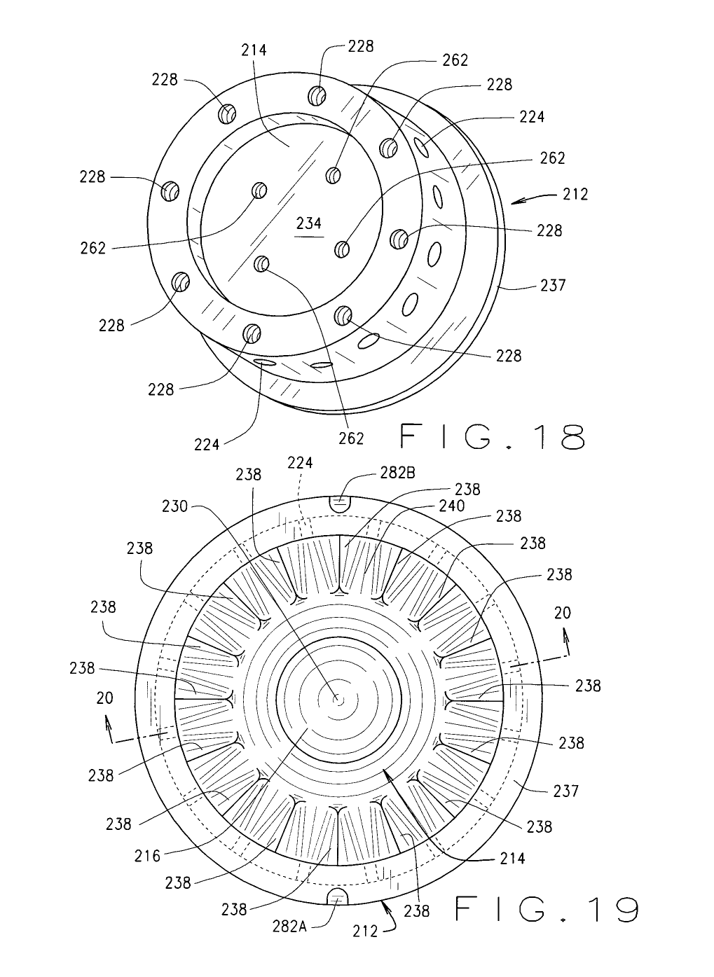

Another aspect of the peripheral die assembly, designated 210, is shown in FIGS. 16-22. As described above for the other aspects, the peripheral die assembly 210 may be used in an extrusion process for extruding an extrusion, such as a vegetable protein-water mixture, in a manner that causes substantial alignment of the protein fibers of the extrusion. In this embodiment, peripheral die assembly 210 includes a cylindrical-shaped die hollow sleeve 212 having an interior wall 266 that defines an interior area 231 adapted to receive a die insert 214 therein. The interior area 231 communicates with a proximal opening 272 at one end of die sleeve 212 and a distal opening 274 at the opposite end thereof adapted to receive an end plate 218 engaged to the die insert 214.

Referring to FIG. 16, the die sleeve 212 also includes a plurality of circular-shaped outlets 224 equidistantly spaced along the body of the die sleeve 212. The plurality of outlets 224 act as individual conduits that communicate with the interior area 231 for permitting formation of the extrusion as the extrusion exits each respective outlet 224 as shall be discussed in greater detail below. In the alternative, the plurality of outlets 224 may have different configurations, such as square, rectangular, scalloped or irregular. As further shown, a circular-shaped flange 237 surrounds proximal opening 272 and defines a pair of opposing slots 282A and 282B that are used to properly align the die sleeve 212 when engaging the die sleeve 212 to the extruding apparatus (not shown).

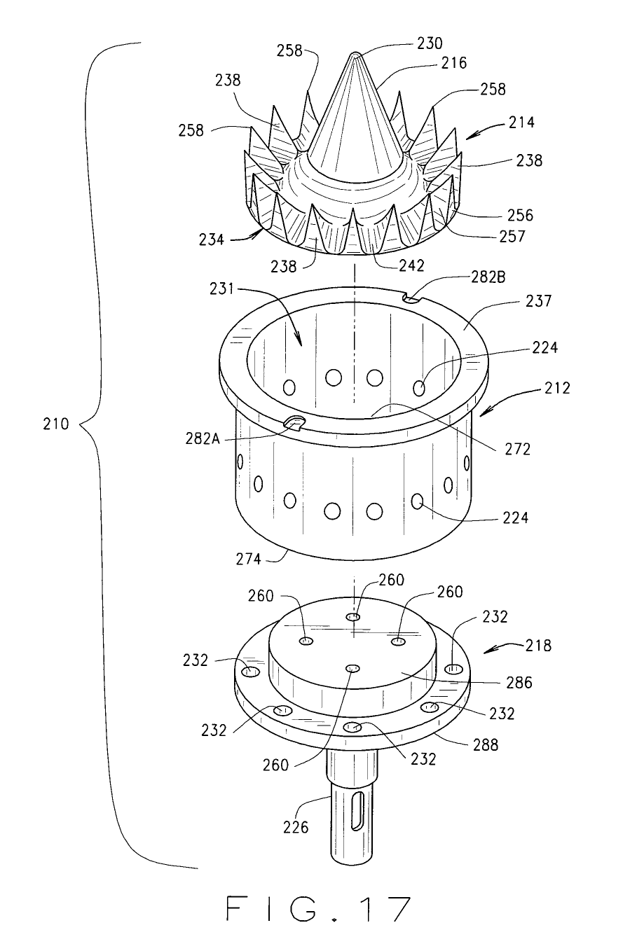

The die sleeve 212 controls the flow of extrusion through the peripheral die assembly 210 and is adapted to receive the die insert 214 for providing the necessary structural elements required to facilitate substantial alignment of the protein fibers of the extrusion as the extrusion passes through the peripheral die assembly 210 during the extrusion process. Referring to FIGS. 17-20, the die insert 214 includes a circular-shaped base 234 that has one side defining a plurality of raised circumferentially-spaced flow diverters 238 and an opposite side that defines a plurality of holes 262 adapted to engage the end plate 218 to the die insert 214. In one embodiment, the die insert 214 may have sixteen flow diverters 238, although it is contemplated that other embodiments may have any of a plurality of flow diverters 238.

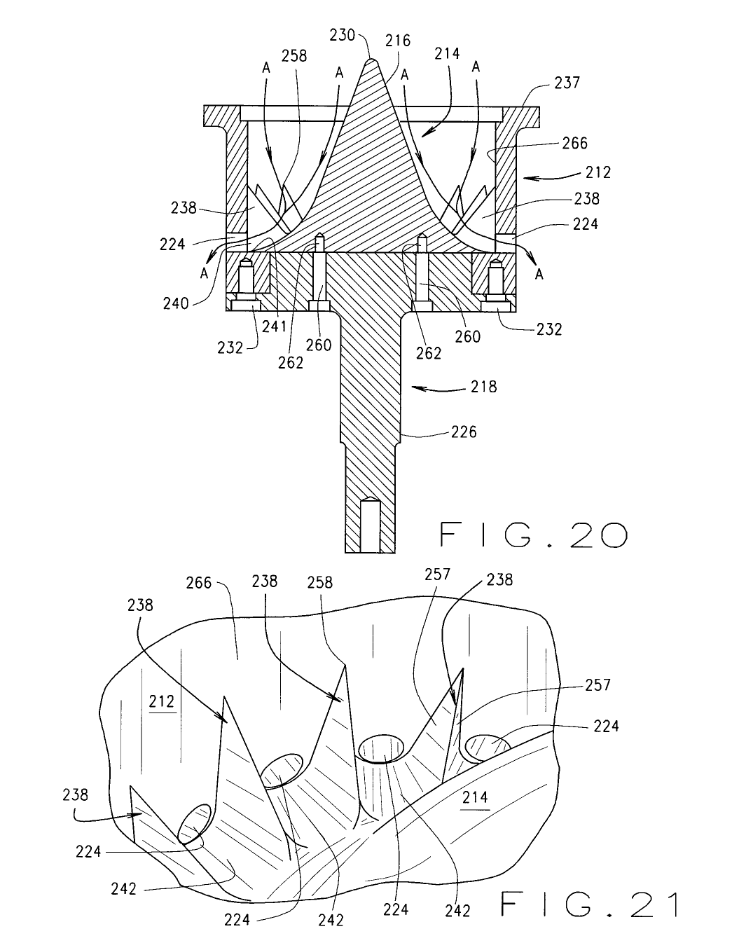

As shown in FIGS. 19 and 21, each of the plurality of raised circumferentially-spaced flow diverters 238 defines opposing tapered side portions 257 that meet at an edge 258 and a back portion 256 that contacts the inner wall 266 of the die sleeve 212 when the die insert 214 is disposed within the interior area 231 and engaged to the die sleeve 212. As illustrated, opposite side portions 257 gradually taper downward to meet and define a flow pathway 240 between each respective flow diverter 238. The flow pathways communicate with a respective outlet 224 for the flow of extrusion that exits the peripheral die assembly 210 during the extrusion process. In the embodiment of the die insert 214 having sixteen flow diverters 238, there will be the same number of flow pathways 240 defined around the circumference of the base 234 which correspond to a respective outlet 224.

Referring to FIGS. 17 and 20, the end plate 218 includes a circular-shaped portion 286 adapted to engage the base 234 of the sleeve insert 214 during assembly of the peripheral die assembly 210. The end plate 218 further includes a flange 288 surrounding the circular-shaped portion 286 and a post 226 that extends axially from the end plate 218. As discussed above, the circular-shaped member 286 defines a plurality of holes 260 that correspond to a plurality of holes 262 of the sleeve insert 214 (FIG. 20) adapted receive a bolt (not shown) for securing the end plate 218 to the die insert 214. Similarly, the flange 288 defines a plurality of equidistantly-spaced apertures 232 that correspond to holes 228 defined around the distal opening 274 of the die sleeve 212 for securing the end plate 218 to the die sleeve 212 with bolts (not shown).

During assembly of the peripheral die assembly 210, the die insert 214 is disposed inside the interior area 231 such that the die insert 214 abuts a shoulder 241 of the die sleeve 212. In this orientation, the back portions 256 of each flow diverter 238 contact the inner wall 266 of the die sleeve 212 in a fluid tight seal. The end plate 218 is then engaged to the base 234 of the die insert 214 by aligning the holes 260 of the end plate 218 with the holes 262 of the die insert which concurrently aligns the holes 228 of the die sleeve 212 with holes 232 of the end plate 218. The bolts are then inserted through the aligned holes 228, 232, 260 and 262 such that the die sleeve 212, die insert 218 and end plate 218 are engaged to one another, thereby completing the assembly of the peripheral die assembly 210.

The plurality of raised, circumferentially-spaced diverters 238 surround a cone portion 216 that extends outwardly through the proximal opening 272 of the die sleeve 212 when the peripheral die assembly 210 is assembled. As shown, the cone portion 216 defines tapered sides that meet at an apex 230 for promoting the flow of extrusion toward the plurality of outlets 224. As illustrated, one end of the flow pathway 240 communicates with the bottom portion of the cone portion 216 while the opposite end of the flow pathway 240 communicates with a respective outlet 224.

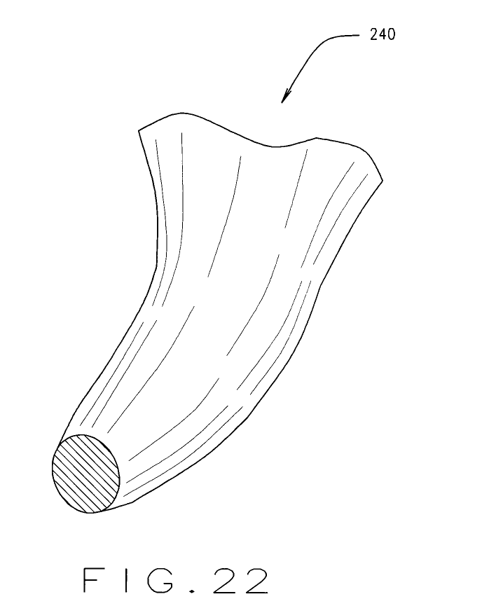

Referring to FIG. 20, during the extrusion process the extrusion flows through the proximal opening 272 of the die sleeve 212 between the cone portion 216 and the inner wall 266 and is directed toward the flow pathways 240 between each adjacent flow diverter 238 as illustrated by flow A. The extrusion has a generally tapered configuration (FIG. 22) as it flows through each respective flow pathway 240 caused by the steeply tapered side portions 257 of the flow diverters 238 before the extrusion exits through a respective outlet 224 of the die sleeve 212. As shown in FIG. 22, the flow pathway 240 has a three-way tapered configuration formed by the die insert 214.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A peripheral die assembly comprising:
a die sleeve defining a plurality of outlets, the die sleeve further defining an interior area in communication with the plurality of outlets, and
a die insert disposed inside the interior area of the die sleeve, the die insert including a base with a cone portion extending outwardly from the base, and a plurality of raised flow diverters circumferentially spaced around the circumference of the base with a flow pathway defined between adjacent flow diverters, wherein the flow pathway is in communication with a respective outlet.

2. The peripheral die assembly of claim 2, wherein each of the plurality of flow diverters defining a back portion and opposing tapered side portions that meet at an edge.

3. The peripheral die assembly of claim 2, wherein the cone portion and the plurality of flow diverters collectively produce a substantially parallel flow by an extrusion flowing through each respective flow pathway.

4. The peripheral die assembly of claim 1, wherein the flow pathway is tapered along three sides.

5. The peripheral die assembly of claim 7, wherein the die sleeve defines an inner wall that includes a shoulder adapted to engage the die insert when the die insert is disposed inside the interior area.

6. The peripheral die assembly of claim 1, further comprising an end plate engaged to the base of the die insert.

7. The peripheral die assembly of claim 6, wherein the end plate includes a circular-shaped portion and a post extending axially from the end plate.

8. The peripheral die assembly of claim 1, wherein the die sleeve defines a proximal opening and an opposing distal opening.

9. The peripheral die assembly of claim 8, wherein the base of the die insert communicates with the distal opening and the cone portion extends outwardly from the proximal opening.

10. The peripheral die assembly of claim 9, wherein an extrusion flows into the proximal opening of the die sleeve between the cone portion and the inner wall and exits a respective outlet through the flow pathway.

11. The peripheral die assembly of claim 1, wherein the die sleeve has a generally cylindrical shape with the outlets being equidistantly spaced around the circumference of the die sleeve.

12. The peripheral die assembly of claim 1, wherein the flow pathway is in communication with a respective outlet at one end and the cone portion at the opposite end thereof.

13. A peripheral die assembly comprising:
a cylindrically-shaped die sleeve defining a plurality of outlets, the die sleeve further defining an interior area in communication with the plurality of outlets,
a die insert disposed inside the interior area of the die sleeve, the die insert including a base with a cone portion extending outwardly from the base, and a plurality of raised flow diverters circumferentially-spaced around the base with a flow pathway defined between adjacent flow diverters, wherein the flow pathway is in communication with a respective outlet at one end and the cone portion at the opposite end thereof; and
an end plate engaged to the die insert through the die sleeve.

14. A die insert adapted to engage a die sleeve for use in an extrusion process comprising:
a generally circular-shaped base have a cone portion extending outwardly from the base, and a plurality of raised circumferentially-spaced flow diverters defined around the base, each of the plurality of flow diverters defining a back portion and opposing side portions that meet to form an edge, wherein opposite side portions of adjacent flow diverters collectively define a flow pathway for the flow of extrusion.

15. A peripheral die assembly comprising:
a die sleeve having an interior area with open ends,
a die insert operatively engaged to the die sleeve having a front face and a rear face with the front face defining a bottom portion and a plurality of raised, circumferentially-spaced flow diverters in communication with an inner space, and
a die cone operatively engaged to the die sleeve and in communication with the plurality of raised, circumferentially-spaced flow diverters for collectively defining a respective flow channel with the flow channel having a tapered configuration along all sides.

16. The peripheral die assembly of 15, wherein each of the raised, circumferentially-spaced flow diverters defines opposing side walls and a face, the face being adapted to engage the die cone when the die cone is engaged to the die insert.

17. The peripheral die assembly of 15, wherein each of the flow channels is defined by any two of the opposing side walls, the bottom portion and the spherically-shaped die cone.

18. The peripheral die assembly of 15, wherein the die cone and the die insert are collectively disposed within the interior area of the die sleeve.

19. The peripheral die assembly of 15, wherein each of the flow channels provides for substantially parallel flow by an extrusion.
